(19) United States
(12) Patent Application Publication
(10) Pub. No.: US 2025/0210848 A1
(43) Pub. Date: Jun. 26, 2025

(54) Electronic Device Handle Antenna

(71) Applicant: Apple Inc., Cupertino, CA (US)

(72) Inventors: Menglou Rao, Austin, TX (US); Jerzy S Guterman, Sunnyvale, CA (US); Joel D Barrera, Cedar Park, TX (US); Panagiotis Theofanopoulos, Cupertino, CA (US)

(21) Appl. No.: 18/390,134

(22) Filed: Dec. 20, 2023

(51) Int. Cl. H01Q 1/22

(52) U.S. Cl. CPC H01Q 1/2258

(57) ABSTRACT

An electronic device such as a desktop computer may have a conductive housing wall and a handle. The handle may have a leg that extends through an opening in the conductive housing wall. The device may include an antenna having an antenna arm. The antenna arm may be layered onto the leg of the handle and may be wrapped around the leg. The antenna arm may have first and second segments parallel to a longitudinal axis of the leg and may have a third segment orthogonal to the longitudinal axis of the leg. The antenna arm may be fed by a conductive screw extending through the conductive housing wall. The antenna may exhibit an omnidirectional radiation pattern over the conductive housing wall that serves to optimize the wireless performance of the device.

### FIELD

This relates generally to electronic devices, including electronic devices with wireless communications capabilities.

### BACKGROUND

Electronic devices such as portable computers and cellular telephones are often provided with wireless communications capabilities and displays. To satisfy consumer demand for small form factor wireless devices, manufacturers are continually striving to implement wireless communications circuitry such as antenna components using compact structures.

It can be challenging to form electronic device antenna structures with desired attributes. In some wireless devices, the presence of conductive housing structures can impact antenna performance. It can be difficult to achieve desired levels of wireless performance in an electronic device, particularly when the device has conductive housing structures.

### SUMMARY

An electronic device such as a desktop computer may have a conductive housing wall and a handle. The handle may have a leg that extends through an opening in the conductive housing wall. The leg may have a longitudinal axis. The leg may include dielectric.

The electronic device may have wireless circuitry. The wireless circuitry may include an antenna. The antenna may have an antenna resonating element that includes an antenna arm. The antenna arm may be a monopole arm, as one example. The antenna arm may be layered onto the dielectric in the leg of the handle. The antenna arm may be wrapped around the leg. The antenna arm may have first and second segments parallel to the longitudinal axis of the leg and may have a third segment orthogonal to the longitudinal axis of the leg. The antenna arm may be fed by a conductive screw extending through the conductive housing wall. The antenna may exhibit an omnidirectional radiation pattern over the conductive housing wall that serves to optimize the wireless performance of the device.

### BRIEF DESCRIPTION OF THE DRAWINGS

FIG. 1 is a schematic diagram of an illustrative electronic device in accordance with some embodiments.

FIG. 2 is a perspective view of an illustrative electronic device that includes one or more electronic device handles in accordance with some embodiments.

FIG. 3 is a schematic diagram of an illustrative antenna that includes a monopole antenna arm in accordance with some embodiments.

FIG. 4 is a schematic diagram of an illustrative antenna that includes a bent monopole antenna arm in accordance with some embodiments.

FIG. 5 is a perspective view of an illustrative electronic device that includes a bent monopole antenna arm wrapped around an electronic device handle in accordance with some embodiments.

FIG. 6 is a cross-sectional side view of a bent monopole antenna arm wrapped around an electronic device handle in accordance with some embodiments.

### DETAILED DESCRIPTION

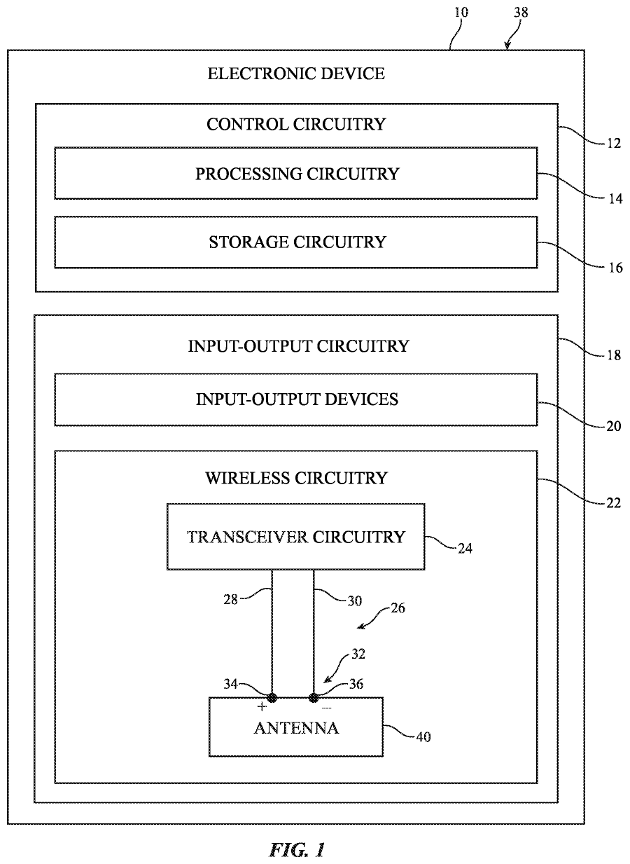

An electronic device such as electronic device 10 of FIG. 1 may contain wireless circuitry. For example, electronic device 10 may contain wireless communications circuitry that operates in long-range communications bands such as cellular telephone bands and wireless circuitry that operates in short-range communications bands such as the 2.4 GHz Bluetooth® or other wireless personal area network (WPAN) bands and the 2.4 GHz and 5 GHz Wi-Fi® band or other wireless local area network (WLAN) bands (sometimes referred to as IEEE 802.11 bands or wireless local area network communications bands). Device 10 may also contain wireless communications circuitry for performing cellular telephone communications, near-field communications, communications at millimeter/centimeter wave frequencies, light-based wireless communications, satellite navigation system communications, or other wireless communications.

Device 10 may be a computing device such as a laptop computer, a desktop computer, a computer monitor containing an embedded computer, a tablet computer, a cellular telephone, a media player, or other handheld or portable electronic device, a smaller device such as a wristwatch device, a pendant device, a headphone or earpiece device, a device embedded in eyeglasses or other equipment worn on a user's head, or other wearable or miniature device, a television, a computer display that does not contain an embedded computer, a gaming device, a navigation device, an embedded system such as a system in which electronic equipment with a display is mounted in a kiosk or automobile, a wireless internet-connected voice-controlled speaker, a wireless base station or access point, equipment that implements the functionality of two or more of these devices, or other electronic equipment. Configurations in which device 10 is a computing device (e.g., a desktop computer, rack-based network device, server device, media player or home speaker device, gaming console, etc.) having one or more electronic device handles are described herein as an example. The electronic device handle(s) may allow a user or another person to easily pick up, place, and/or move the device (e.g., in implementations where the device is too heavy to easily lift by its housing or case alone).

As shown in FIG. 1, device 10 may include control circuitry such as control circuitry 12. Control circuitry 12 may include storage such as storage circuitry 16 and processing circuitry such as processing circuitry 14. Storage circuitry 16 may include hard disk drive storage, nonvolatile memory (e.g., flash memory or other electrically-programmable-read-only memory configured to form a solid-state drive), volatile memory (e.g., static or dynamic random-access-memory), etc. Processing circuitry 14 be used to control the operation of device 10. Processing circuitry 14 may include one or more processors such as microprocessors, microcontrollers, digital signal processors, host processors, baseband processor integrated circuits, application specific integrated circuits, central processing units (CPUs), graphics processing units (GPUs), etc.

Control circuitry 12 may be configured to perform operations in device 10 using hardware (e.g., dedicated hardware or circuitry), firmware, and/or software. Software code for performing operations in device 10 may be stored on control circuitry 12 (e.g., storage in control circuitry 12 may include non-transitory (tangible) computer readable storage media that stores the software code). The software code may sometimes be referred to as program instructions, software, data, instructions, or code. Software code stored on the storage may be executed by processing circuitry in control 12.

Control circuitry 12 may be used to run software on device 10 such as internet browsing applications, voice-over-internet-protocol (VOIP) telephone call applications, email applications, media playback applications, operating system functions, etc. To support interactions with external equipment, control circuitry 12 may be used in implementing communications protocols. Communications protocols that may be implemented using control circuitry 12 include internet protocols, wireless local area network protocols (e.g., IEEE 802.11 protocols-sometimes referred to as WiFi®), protocols for other short-range wireless communications links such as the Bluetooth® protocol or other WPAN protocols, IEEE 802.11ad protocols, cellular telephone protocols, multiple-input and multiple-output (MIMO) protocols, antenna diversity protocols, satellite navigation system protocols, antenna-based spatial ranging protocols (e.g., radio detection and ranging (RADAR) protocols or other desired range detection protocols for signals conveyed at millimeter and centimeter wave frequencies), etc. Each communication protocol may be associated with a corresponding radio access technology (RAT) that specifies the physical connection methodology used in implementing the protocol.

Device 10 may include input-output circuitry 18. Input-output circuitry 18 may include input-output devices 20. Input-output devices 20 may be used to allow data to be supplied to device 10 and to allow data to be provided from device 10 to external devices. Input-output devices 20 may include user interface devices, data port devices, and other input-output components. For example, input-output devices 20 may include touch sensors, displays, light-emitting components such as displays without touch sensor capabilities, buttons (mechanical, capacitive, optical, etc.), scrolling wheels, touch pads, key pads, keyboards, microphones, cameras, buttons, speakers, status indicators, audio jacks and other audio port components, digital data port devices, motion sensors (accelerometers, gyroscopes, and/or compasses that detect motion), capacitance sensors, proximity sensors, magnetic sensors, force sensors (e.g., force sensors coupled to a display to detect pressure applied to the display), networking circuitry (e.g., one or more network cards, ethernet components, etc.), etc. In some configurations, keyboards, headphones, displays, gaming controllers, pointing devices such as trackpads, mice, and joysticks, and other input-output devices may be coupled to device 10 using wired or wireless connections (e.g., some of input-output devices 20 may be peripherals that are coupled to a main processing unit or other portion of device 10 via a wired or wireless link).

Input-output circuitry 18 may include wireless circuitry 22 to support wireless communications with external equipment. The external equipment with which device 10 communicates wirelessly may be a computer, a cellular telephone, a watch, a router, access point, or other wireless local area network equipment, a wireless base station in a cellular telephone network, a display, a head-mounted device, or other electronic equipment. Wireless circuitry 22 may include radio-frequency (RF) transceiver circuitry 24 and one or more antennas such as antenna 40. Device 10 may include any desired number of antennas 40.

Transceiver circuitry 24 may include one or more integrated circuits (chips), power amplifier circuitry, low-noise amplifier circuitry, filter circuitry, mixer circuitry, analog-to-digital converter (ADC) circuitry, digital-to-analog converter (DAC) circuitry, clocking circuitry, switching circuitry, and/or any other desired circuitry used in transmitting and/or receiving radio-frequency signals using antenna 40. Transceiver circuitry 24 may support communications in Extremely High Frequency (EHF) or millimeter wave communications bands between about 30 GHz and 300 GHz, in centimeter wave communications bands between about 10 GHz and 30 GHz (sometimes referred to as Super High Frequency (SHF) bands), wireless local area network (WLAN) communications bands such as the 2.4 GHz and 5 GHz Wi-Fi® (IEEE 802.11) bands, wireless personal area network (WPAN) communications bands such as the 2.4 GHz Bluetooth® communications band, cellular telephone communications bands such as a cellular low band (LB) (e.g., 600 to 960 MHz), a cellular low-midband (LMB) (e.g., 1400 to 1550 MHz), a cellular midband (MB) (e.g., from 1700 to 2200 MHz), a cellular high band (HB) (e.g., from 2300 to 2700 MHZ), a cellular ultra-high band (UHB) (e.g., from 3300 to 5000 MHz, or other cellular communications bands between about 600 MHz and about 5000 MHz (e.g., 3G bands, 4G LTE bands, 5G New Radio Frequency Range 1 (FR1) bands below 10 GHz, etc.), a near-field communications (NFC) band (e.g., at 13.56 MHz), satellite navigations bands (e.g., an L1 global positioning system (GPS) band at 1575 MHz, an L5 GPS band at 1176 MHz, a Global Navigation Satellite System (GLONASS) band, a BeiDou Navigation Satellite System (BDS) band, etc.), ultra-wideband (UWB) communications band(s) supported by the IEEE 802.15.4 protocol and/or other UWB communications protocols (e.g., a first UWB communications band at 6.5 GHz and/or a second UWB communications band at 8.0 GHz), and/or any other desired communications bands. The communications bands handled by the radio-frequency transceiver circuitry may sometimes be referred to herein as frequency bands or simply as “bands,” and may span corresponding ranges of frequencies.

While control circuitry 12 is shown separately from wireless circuitry 22 in the example of FIG. 1 for the sake of clarity, wireless circuitry 22 may include processing circuitry that forms a part of processing circuitry 14 and/or storage circuitry that forms a part of storage circuitry 16 of control circuitry 12 (e.g., portions of control circuitry 12 may be implemented on wireless circuitry 22). As an example, control circuitry 12 (e.g., processing circuitry 14) may include baseband circuitry (e.g., one or more baseband processors) or other control components that form a part of wireless circuitry 22.

Transceiver circuitry 24 may convey radio-frequency signals using one or more antennas 40 (e.g., antennas 40 may convey the radio-frequency signals for the transceiver circuitry). The term “convey radio-frequency signals” as used herein means the transmission and/or reception of the radio-frequency signals (e.g., for performing unidirectional and/or bidirectional wireless communications with external wireless communications equipment). Antennas 40 may transmit the radio-frequency signals by radiating the radio-frequency signals into free space (or to free space through intervening device structures such as a dielectric cover layer). Antennas 40 may additionally or alternatively receive the radio-frequency signals from free space (e.g., through intervening devices structures such as a dielectric cover layer). The transmission and reception of radio-frequency signals by antennas 40 each involve the excitation or resonance of antenna currents on an antenna resonating element in the antenna by the radio-frequency signals within the frequency band(s) of operation of the antenna.

Antennas 40 in wireless circuitry 34 may be formed using any suitable antenna structures. For example, antennas 40 may include antennas with resonating elements that are formed from loop antenna structures, patch antenna structures, inverted-F antenna structures, slot antenna structures, planar inverted-F antenna structures, helical antenna structures, monopole antenna structures, dipole antenna structures, dielectric resonator antenna structures, hybrids of these designs, etc. Parasitic elements may be included in antennas 40 to adjust antenna performance. An antenna 40 may be provided with a conductive cavity that backs the antenna resonating element of antenna 40 (e.g., antenna 40 may be a cavity-backed antenna). In some configurations, device 10 may have isolation elements between respective antennas 40 to help avoid antenna-to-antenna cross-talk. Different types of antennas may be used for different bands and combinations of bands. If desired, two or more antennas 40 may be arranged in a phased antenna array that conveys radio-frequency signals using beamforming techniques (e.g., at frequencies greater than 10 GHz).

As shown in FIG. 1, transceiver circuitry 24 may be coupled to antennas such as antenna 40 using radio-frequency transmission line paths such as transmission line path 26. Transmission line paths in device 10 such as transmission line path 26 may include coaxial cables, microstrip transmission lines, stripline transmission lines, edge-coupled microstrip transmission lines, edge-coupled stripline transmission lines, waveguide transmission lines (e.g., coplanar waveguides, grounded coplanar waveguides, etc.), feed probes, transmission lines formed from combinations of transmission lines of these types, etc.

Transmission line path 26 may be coupled to antenna 40 at antenna feed 32. Antenna feed 32 may include a positive antenna feed terminal such as positive antenna feed terminal 34 and may include a ground antenna feed terminal such as ground antenna feed terminal 36. Transmission line path 26 may have a positive transmission line signal path such as path 28 that couples transceiver circuitry 24 to positive antenna feed terminal 34. Transmission line path 26 may have a ground transmission line signal path such as path 30 that couples transceiver circuitry 24 to ground antenna feed terminal 36. Path 28 may sometimes be referred to herein as signal conductor 28 and path 30 may sometimes be referred to herein as ground conductor 30. The feeding configuration of FIG. 1 is illustrative and non-limiting. Other types of antenna feed arrangements may be used (e.g., indirect feed arrangements, feed arrangements in which antenna 40 is fed using multiple feeds, etc.). If desired, multiple antennas 40 may concurrently operate in the same frequency bands (e.g., using a MIMO scheme).

Transmission line paths in device 10 such as transmission line path 26 may be integrated into rigid and/or flexible printed circuit boards if desired. In one suitable arrangement, transmission line paths in device 10 may include transmission line conductors (e.g., signal and/or ground conductors) that are integrated within multilayer laminated structures (e.g., layers of a conductive material such as copper and a dielectric material such as a resin that are laminated together without intervening adhesive) that may be folded or bent in multiple dimensions (e.g., two or three dimensions) and that maintain a bent or folded shape after bending (e.g., the multilayer laminated structures may be folded into a particular three-dimensional shape to route around other device components and may be rigid enough to hold its shape after folding without being held in place by stiffeners or other structures). All of the multiple layers of the laminated structures may be batch laminated together (e.g., in a single pressing process) without adhesive (e.g., as opposed to performing multiple pressing processes to laminate multiple layers together with adhesive).

Filter circuitry, switching circuitry, impedance matching circuitry, and other circuitry may be interposed within transmission line path 26 and/or circuits such as these may be incorporated into antenna 40 (e.g., to support antenna tuning, to support operation in desired frequency bands, etc.). During operation, control circuitry 12 may use radio-frequency transceiver circuitry 24 and antenna(s) 40 to transmit and/or receive wireless data (e.g., wireless data organized into symbols, packets, frames, etc.). Control circuitry 12 may, for example, receive wireless local area network communications wirelessly using radio-frequency transceiver circuitry 24 and antenna(s) 40 and may transmit wireless local area network communications wirelessly using radio-frequency transceiver circuitry 24 and antenna(s) 40.

Electronic device 10 may be provided with electronic device housing 38. Housing 38, which may sometimes be referred to as a case, may be formed of plastic, glass, ceramics, fiber composites, metal (e.g., stainless steel, aluminum, etc.), other suitable materials, or a combination of these materials. Housing 38 may be formed using a unibody configuration in which some or all of housing 38 is machined or molded as a single structure or may be formed using multiple structures (e.g., an internal frame structure covered with one or more outer housing layers). Configurations for housing 38 in which housing 38 includes support structures (a stand, leg(s), handles, etc.) may also be used. In one suitable arrangement that is described herein as an example, housing 38 includes a conductive housing (e.g., conductive housing walls, a conductive frame, both a conductive inner frame and a conductive outer frame, a conductive shell, and/or other conductive housing structures) and one or more electronic device handles. The electronic device handles may be used to help pick up, carry, move, or position device 10 (e.g., on a desktop, tabletop, network rack, or other surface). The electronic device handles may be secured (affixed) to a conductive housing wall and/or a frame of housing 38.

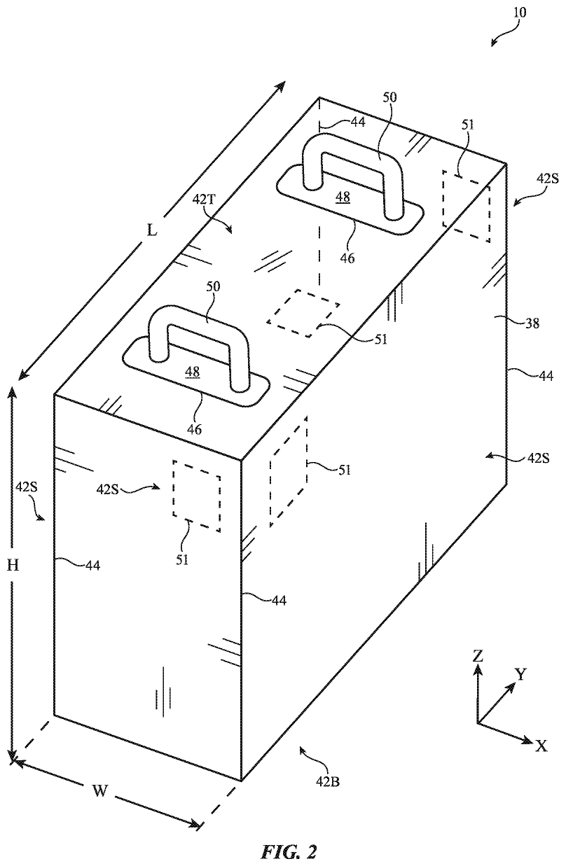

A perspective view of an illustrative electronic device such as device 10 of FIG. 1 is shown in FIG. 2. In the example of FIG. 2, housing 38 is provided with a rectangular box shape. In general, device 10 may have a housing with any suitable shape (e.g., a box shape with a different number of sides, pyramidal, cylindrical, conical, spherical, a shape with a combination of curved sides and planar sides, etc.). The box-shaped housing of FIG. 2 is illustrative.

As shown in FIG. 2, housing 38 may be characterized by a width W, a height H, and a length L. The values of W, H, and L may be at least 1 mm, at least 10 mm, at least 100 mm, at least 300 mm, may be less than 1000 mm, less than 750 mm, may be less than 500 mm, may be less than 250 mm, or may be any other suitable value. In some configurations, housing 38 is low and wide (e.g., H may be less than W and less than L). In other configurations, housing 38 may be thinner and taller. For example, H may be at least two times W, at least 3 times W, or other suitably large value. If desired, L may be larger than W (e.g., L may be at least 1.5 times W, 2 times W, at least three times W, etc.). Other shapes and sizes may be used for housing 38 if desired. The example of FIG. 2 is illustrative.

Housing 38 may have edges such as edges that extend along the four corners 44 of housing 38 of FIG. 2 (e.g., the four corners of housing 38 when an outline of housing 38 is viewed from above). Each corner 44 may, for example, have an edge that extends vertically along vertical the Z-axis. Housing walls may be formed on the top and bottom of housing 38 (e.g., walls that lie parallel to the X-Y plane), the left and right sides of housing 38 (walls that lie parallel to the Y-Z plane), and/or on the front and rear sides of housing 38 (walls that lie parallel to the X-Z plane). In the example of FIG. 2, housing 38 has a bottom wall 42B, a top wall 42T, and four side walls 42S extending from bottom wall 42B to top wall 42T. In this type of arrangement, walls 42S, 42T, and 42B form an enclosure for device 10 that is a six-sided box.

Walls 42T, 42B, and/or 42S may be formed from conductive material such as metal (e.g., aluminum, steel, titanium, etc.), other conductive materials, and/or insulating material (e.g., polymer, etc.). Walls 42T, 42B, and 42S are therefore sometimes also referred to herein as conductive housing walls or simply as conductive walls. If desired, walls 42T, 42B, and/or 42S, or portions of walls 42T, 42B, and/or 42S may have areas such as areas 51 to accommodate buttons and other input-output devices 20 (FIG. 1), ports for coupling to removable storage media, ports that facilitate coupling to peripherals (e.g., data ports), audio ports, air vents for drawing air into the interior of housing 38, air vents for expelling air out of the interior of housing 38, etc. Areas 51 may be located on one or more of walls 42T, 42B, and 42S (as an example). For example, an area 51 that contains a power port and data and display ports and may be located on the rear wall of housing 38.

Housing 38 may include openings 46. Openings 46 may be formed in one of the walls of housing 38 such as top wall 42T. Electronic device handles such as electronic device handles 50 may protrude through openings 46. Device 10 may have one, two, or more than two electronic device handles 50. In one suitable arrangement that is sometimes described herein as an example, device 10 includes two electronic device handles 50 protruding through two respective openings 46.

Support structures for electronic device handles 50 such as conductive support plates 48 may be aligned with (e.g., disposed within) openings 46. In implementations that are described herein as an example, top wall 42T and conductive support plates 48 are formed using conductive material such as metal (e.g., aluminum, steel, iron, silver, gold, copper, metal alloys, etc.). This is merely illustrative and, if desired, some or all of housing 38, top wall 42T, and/or conductive support plate 48 may be formed from dielectric materials.

Electronic device handles 50 may include dielectric material (e.g., may be formed from dielectric materials). Electronic device handles 50 are therefore sometimes also referred to herein as dielectric handles 50, carrying handles 50, device handles 50, mechanical handles 50, or simply as handles 50. Conductive support plates 48 may help to hold handles 50 in place and may help to protect the interior of housing 38 from contamination and damage. Handles 50 may be secured to conductive support plates 48 using adhesive, solder, welds, screws, or other fastening structures. Additionally or alternatively, handles 50 may extend through openings (holes) in conductive support plates 48 (e.g., without being adhered or affixed to conductive support plates 48 or in addition to being adhered to conductive support plates 48). This may allow handles 50 to pass through conductive support plates 48 and to be secured to an internal frame of housing 38 or other support structures within device 10 to help hold or fix the handles in place relative to top wall 42T.

Conductive support plates 48 may sometimes be referred to herein as conductive plates 48, conductive islands 48 (e.g., because conductive support plates 48 may be aligned with openings 46 without contacting the conductive outer sleeve for housing 38), or conductive members 48. The example of FIG. 2 in which top wall 42T includes openings 46 and conductive support plates 48 is illustrative and non-limiting. If desired, conductive support plates 48 and openings 46 may be omitted and handles 50 may be mounted directly to top wall 42T and/or may pass through openings in top wall 42T.

One or more antennas such as antenna 40 of FIG. 1 may be disposed on device 10 to handle wireless communications. In some configurations, antennas are formed from internal device components (e.g., antenna traces on printed circuit boards mounted within the interior of housing 38). However, in scenarios where housing 38 is formed from metal, the metal in housing 38 can undesirably block antennas formed from internal device components from conveying radio-frequency signals with external wireless communications equipment. In other configurations, antennas are formed from radiating slots in conductive support plates 48. However, antennas having radiating slots in conductive support plates 48 can exhibit excessive directivity and gain in a particular direction (e.g., in the +Z direction). This can cause the antennas to exhibit excessive emission in that direction (e.g., emission exceeding a regulatory limit on electromagnetic emission or exposure to a user such as specific absorption rate (SAR) limits or maximum permissible exposure (MPE) limits) and/or can require precise placement of device 10 in a specific orientation to ensure that the antenna exhibits satisfactory levels of performance in conveying radio-frequency signals with external equipment (e.g., an orientation with a direction of peak gain pointed towards the external equipment). This can limit the number of locations where the user can place device 10 and/or can undesirably disrupt wireless communications using device 10.

To mitigate these issues and to provide antenna 40 with as omnidirectional a radiation pattern as possible, thereby allowing the antenna to communicate with external equipment regardless of the placement orientation of device 10 and minimizing the risk of exceeding regulatory limits on electromagnetic emission or exposure, antenna 40 may be disposed on a handle 50 of device 10. The antenna may, for example, have an antenna arm that is at least partially wrapped around a portion of handle 50. The antenna arm may be, in one example, a monopole arm.

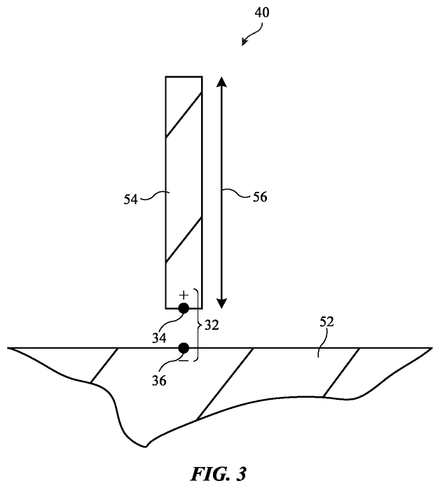

FIG. 3 is a diagram of an antenna 40 having a monopole arm. As shown in FIG. 3, antenna 40 may include an antenna resonating element such as antenna arm 54 and a ground plane such as antenna ground 52. The ground antenna feed terminal 36 of antenna feed 32 is coupled to antenna ground 52. The positive antenna feed terminal 34 of antenna feed 32 is coupled to antenna arm 54. Antenna arm 54 is sometimes also referred to herein as radiating arm 54 or resonating element arm 54.

In the example of FIG. 3, antenna arm 54 is implemented as a monopole arm (e.g., a monopole antenna resonating or radiating element). Antenna arm 54 has a first end coupled to positive antenna feed terminal 34 and has a second end opposite the first end that is electrically floating. Antenna arm 54 has a length 56 from the first end to the second end (e.g., along a longest dimension of the arm). Length 56 may be selected to configure antenna 40 to radiate (e.g., resonate) in a corresponding frequency band. Length 56 may, for example, be approximately equal to half the effective wavelength corresponding to a frequency in the frequency band (e.g., a center frequency of the frequency band, where the effective wavelength is equal to a vacuum wavelength modified by the dielectric properties of the materials around antenna arm 54). During transmission, antenna current flows around the edges of antenna arm 54 and antenna ground 52 to radiate radio-frequency signals. During reception, incident radio-frequency signals produce antenna current that flows around the edges of antenna arm 54 and antenna ground 52. Antenna arm 54 may exhibit one or more resonances in a fundamental mode and/or one or more harmonic modes associated with length 56.

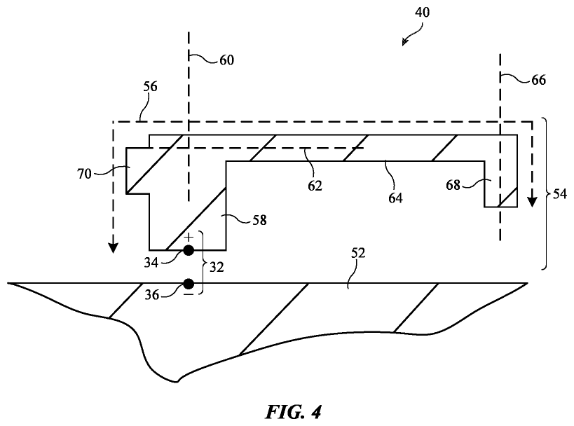

The example of FIG. 3 in which antenna arm 54 is straight is illustrative and non-limiting. In general, antenna arm 54 may have any desired shape having any desired number of straight and/or curved segments (e.g., along a linear path, a curved path, a meandering path, etc.) and/or may have any desired number of straight and/or curved edges. If desired, antenna arm 54 may be a bent monopole arm that is bent or folded around one or more axes. FIG. 4 is a diagram of an antenna 40 having a bent monopole arm.

As shown in FIG. 4, antenna arm 54 may have a first portion such as segment 58 extending from the first end of antenna arm 54, a second portion such as segment 64 extending from the end of segment 58, and a third portion such as segment 68 extending from the end of segment 64 to the second end of antenna arm 54. Positive antenna feed terminal 34 may be coupled to the end of segment 58 opposite segment 64. The length 56 of antenna arm 54 extends from the end of segment 58, through segment 58, through segment 64, and through segment 68 to the end of segment 68.

Segment 58 may extend along a first longitudinal axis 60. Segment 64 may extend along a second longitudinal axis 62 that is different from longitudinal axis 62. Longitudinal axis 62 may be oriented at a non-parallel angle such as an orthogonal angle with respect to longitudinal axis 60 (e.g., segment 64 may extend perpendicular to segment 58). Segment 68 may extend along a third longitudinal axis 66 that is different from longitudinal axis 62. Longitudinal axis 66 may be oriented at a non-parallel angle such as an orthogonal angle with respect to longitudinal axis 62 and/or may be parallel to longitudinal axis 60 (e.g., segment 68 may extend perpendicular to segment 64 and/or parallel to segment 58).

Antenna arm 54 may convey radio-frequency signals in one or more frequency bands. For example, antenna arm 54 may exhibit a fundamental mode and/or one or more harmonic modes that collectively cover a relatively low frequency band (e.g., between around 2.0 GHz and 3.0 GHZ) and a relatively high frequency band (e.g., between around 5.0 GHz and 7.5 GHZ). If desired, antenna arm 54 may include one or more stubs or tabs such as a tab 70 extending from an edge of segment 58. Tab 70 may be an impedance matching stub that helps to match the impedance of antenna 40 to the impedance of the transmission line path coupled to antenna feed 32 and/or may help add and/or tune one or more resonant modes of antenna arm 54 (e.g., a response of antenna 40 in the relatively high frequency band). As one example, segment 64 may be 15-25 mm in length (e.g., along axis 62), segment 68 may be 5-15 mm in length (e.g., along axis 66), segment 58 may be 3-10 mm wide (e.g., orthogonal to axis 60), and tab 70 may be 1-5 mm in height (e.g., parallel to axis 60).

Implementing antenna arm 54 as a bent monopole arm in this way may help to optimize the radiation pattern of antenna 40 when mounted to a handle 50 in device 10 (e.g., by minimizing the directivity of the radiation pattern so the antenna has as omnidirectional an antenna pattern as possible). The example of FIG. 4 in which antenna arm 54 of FIGS. 3 and 4 is a monopole arm is illustrative and non-limiting. If desired, antenna arm 54 may be a dipole arm (e.g., antenna 40 may include a pair of dipole arms on handle 50), an inverted-F antenna arm (e.g., in implementations where a segment of antenna arm 54 is shorted to antenna ground 52 by a return path, which may serve to reduce the volume of antenna 40 for covering a particular band and/or which may configure length 56 to be approximately equal to one-quarter of the effective wavelength of operation of antenna 40), a helical antenna arm, or an arm of another type of antenna resonating element (e.g., a branch of a slot antenna resonating element, an arm of a patch antenna resonating element, a branch or arm of a loop antenna resonating element, etc.).

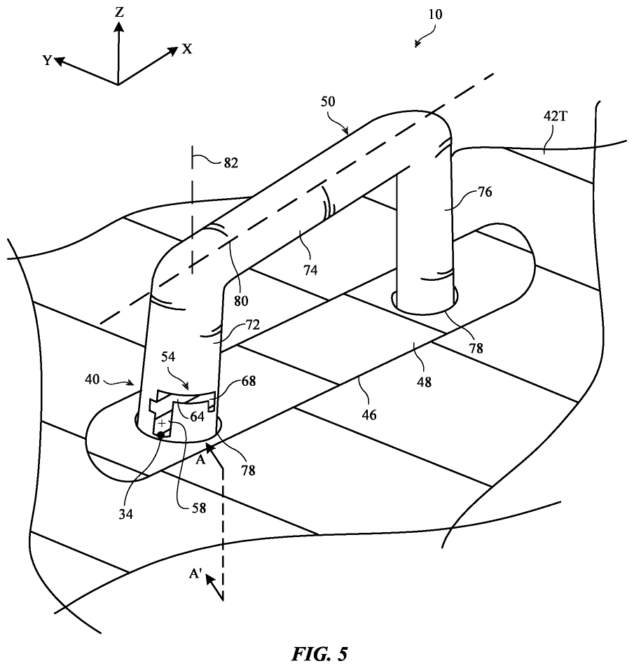

FIG. 5 is a perspective view showing how antenna arm 54 may be mounted to a handle 50 on device 10. As shown in FIG. 5, conductive support plate 48 may be disposed within an opening 46 in the top wall 42T of device 10. Handle 50 may be mounted and/or attached to conductive support plate 48 and/or may pass through one or more openings in conductive support plate 48 such as openings 78. The example of FIG. 5 in which top wall 42T includes opening 46 and conductive support plate 48 is illustrative and non-limiting. Alternatively, conductive support plate 48 and opening 46 may be omitted and handle 50 may be mounted directly to top wall 42T and/or may pass through openings in top wall 42T (e.g., openings 78 may be formed in top wall 42T rather than in a separate conductive support plate or, equivalently, conductive support plate 48 and top wall 42T may be formed from integral portions of a single piece of metal).

Top wall 42T and conductive support plate 48 may be formed from metal. Handle 50 may be formed from dielectric material (e.g., plastic, ceramic, glass, polymer, rubber, etc.). As such, handle 50 may pass through openings 78 without being electrically shorted to conductive support plate 48 or top wall 42T. Handle 50 may have a one or more vertical portions (segments) such as a first leg 72 and a second leg 76. Legs 72 and 76 may be mounted to conductive support plate 48 and/or top wall 42T and/or may pass through respective openings 78. Leg 72 may extend along a vertical axis 82 (e.g., the longitudinal axis of leg 72). Leg 76 may extend along a vertical axis parallel to vertical axis 82. Vertical axis 82 may be oriented orthogonal to the lateral surface (plane) of top wall 42T and/or conductive support plate 48 (e.g., parallel to the Z-axis of FIG. 5).

Handle 50 may have a horizontal portion such as horizontal segment 74. Horizontal segment 74 may extend from leg 72 to leg 76. Horizontal segment 74 may extend along horizontal axis 80 (e.g., the longitudinal axis of horizontal segment 74). Horizontal axis 80 may be oriented parallel to the lateral surface (plane) of top wall 42T and/or conductive support plate 48 (e.g., parallel to the X-axis of FIG. 5) and/or may be orthogonal to vertical axis 82. A user may insert their hand under horizontal segment 74 to grab handle 50 when picking up or moving device 10. Legs 72 and 76 may hold horizontal segment 74 in place on device 10 when the user grabs handle 50.

As shown in FIG. 5, antenna arm 54 may be disposed, mounted to, and/or layered onto handle 50. For example, antenna arm 54 may be layered onto leg 72 of handle 50 (e.g., at the end of leg 72 opposite horizontal segment 74, at or adjacent conductive support plate 48 and/or top wall 42T). Segment 58 may extend along or parallel to vertical axis 82 (e.g., axis 60 of FIG. 4 may be parallel to vertical axis 82).

Antenna arm 54 may be wrapped, bent, wound, or folded around leg 72 and vertical axis 82. As such, segment 64 may extend around the circumference of leg 72 (e.g., parallel to the X-Y plane) and around vertical axis 82 (e.g., axis 62 of FIG. 4 may be orthogonal to vertical axis 82). Similarly, the conductive material in segments 58 and 68 may exhibit a non-zero curvature about vertical axis 82. Segment 68 may extend along or parallel to vertical axis 82 (e.g., axis 66 of FIG. 4 may be parallel to vertical axis 82) away from the end of segment 64 and towards conductive support plate 48 and/or top wall 42T. Antenna arm 54 may be wrapped around leg 72 and vertical axis 72 by any desired angle (e.g., may extend around vertical axis 82 by 90 degrees, 30-90 degrees, 45 degrees, 45-90 degrees, 30-60 degrees, 30-120 degrees, 45-180 degrees, 30-270 degrees, 45-300 degrees, 180-350 degrees, 30-330 degrees, more than 180 degrees, more than 270 degrees, more than 210 degrees, more than 180 degrees, more than 90 degrees, more than 45 degrees, less than 330 degrees, less than 370 degrees, or other angles).

Wrapping antenna arm 54 around the circumference of leg 72 and vertical axis 82 in this way may configure antenna 40 to exhibit as omnidirectional a radiation as possible while minimizing the impact of conductive support plate 48 and/or top wall 42T on antenna 40, thereby optimizing antenna performance while satisfying regulatory requirements on electromagnetic emission/absorption.

Handle 50 may be formed from a dielectric material that is sufficiently rigid to mechanically support device 10 when carried but that does not excessively impact the radio-frequency performance of antenna 40. Handle 50 may, for example, be formed from a dielectric material having a dielectric permittivity εᵣ of 3-4, 3.5-3.6, 3.2-3.8, 2-5, less than 5, greater than 2, greater than 3, less than 6, or other values.

Antenna arm 54 may, for example, be formed from conductive traces that are layered or patterned onto leg 72 of handle 50 (e.g., using a laser direct structuring (LDS) process, an etching process, etc.). Alternatively, antenna arm 54 may be formed from metal foil or sheet metal that is pressed and/or adhered to leg 72 of handle 50 (e.g., using adhesive). Alternatively, antenna arm 54 may be formed from conductive traces on a flexible printed circuit that is layered onto leg 72 and wrapped around leg 72 and vertical axis 82.

Antenna arm 54 may be layered onto an exterior surface of a dielectric portion of leg 72. If desired, handle 50 may be provided with a thin dielectric cover layer (not shown) that is disposed over handle 50 and antenna arm 54. The thin dielectric cover layer may be formed from plastic, one or more dielectric coatings, rubber, ceramic, glass, and/or other materials. The thin dielectric cover layer may help to hide antenna arm 54 from view and/or to protect antenna arm 54 from being shorted, detuned, and/or damaged during use of device 10 and/or handle 50.

If desired, handle 50 may include conductive structures within leg 72, horizontal segment 74, and/or leg 76 such as metal reinforcement bars or a metal frame (e.g., handle 50 may be entirely dielectric or may be formed from dielectric that is provided with one or more metal reinforcement members). The conductive structures may help to maximize the mechanical strength of handles 50 and may help to secure handle 50 to device 10. The conductive structures may be electrically floating and/or may be coupled to a ground potential. In these implementations, dielectric portions of handle 50 are interposed between antenna arm 54 and the conductive structures to prevent shorting of the antenna arm to the conductive structures. If desired, handle 50 may be hollow and may have an interior cavity (e.g., in leg 72, horizontal segment 74, and/or leg 76). In these implementations, antenna arm 54 may be layered onto an interior surface of leg 72 within the interior cavity. The interior cavity may be filled with air or other dielectric materials, for example.

If desired, antenna arm 54 may be wrapped around leg 76 instead of leg 72. Alternatively, antenna arm 54 may be disposed on horizontal segment 74 and wrapped around horizontal segment 74 and horizontal axis 80. If desired, device 10 may include multiple antennas such as antenna 40 that are wrapped around leg 72, horizontal segment 74, and/or leg 76 (e.g., for covering different frequency bands and/or providing MIMO coverage). If desired, multiple handles 50 or all handles 50 on device 10 may include one or more antennas 40 (e.g., for covering different frequency bands and/or providing MIMO coverage).

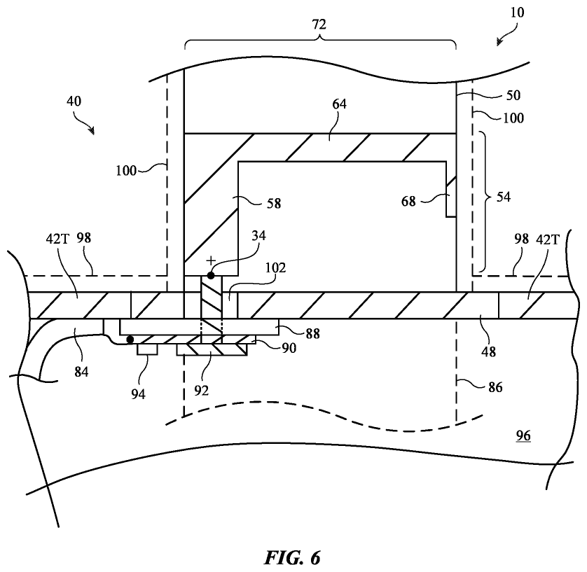

When disposed on leg 76 as shown in FIG. 5, antenna 40 may be fed through conductive support plate 48 and/or top wall 42T. FIG. 6 is a cross-sectional side view of device 10 (e.g., as taken in the direction of line AA′ of FIG. 5) showing one example of how antenna 40 may be fed through conductive support plate 48 and/or top wall 42T.

As shown in FIG. 6, handle 50 may be mounted to conductive support plate 48 in top wall 42T. If desired, handle 50 may extend through opening 78 (FIG. 5) into the interior 96 of device 10, as shown by dashed lines 86. Alternatively, conductive support plate 48 may be replaced with an integral portion of top wall 42T and opening 78 (FIG. 5) may be formed in top wall 42T.

If desired, device 10 may include an inner metal housing or frame within interior 96 (not shown), where top wall 42T forms part of an outer metal frame or sleeve that is slid onto and over the inner metal housing or frame. This is illustrative and non-limiting and, if desired, the inner metal housing or frame may be omitted. Conductive support plate 48 (or top wall 42T in implementations where conductive support plate 48 is omitted) may include an opening such as hole 102. Hole 102 may be a different opening from opening 78 (FIG. 5) or may be formed from a part of opening 78.

Device 10 may include a transmission line 84 (e.g., a coaxial cable) for antenna 40 and a printed circuit board 88 within interior 96. Printed circuit board 88 may be mounted or layered onto an interior surface of top wall 42T. Printed circuit board 88 may include one or more conductive traces 90 (e.g., radio-frequency signal traces). Conductive traces 90 may be on a surface of printed circuit board 88 and/or may be embedded within printed circuit board 88. Printed circuit board 88 may be a rigid printed circuit board or a flexible printed circuit board or may be replaced with a dielectric substrate. Printed circuit board 88 may include one or more radio-frequency components 94 disposed on (e.g., surface-mounted to) conductive traces 90. Radio-frequency components 94 may include one or more capacitors, inductors, resistors, filters, switches, and/or other radio-frequency front end circuitry for antenna 40 (e.g., a tuning circuit for antenna 40, and impedance matching circuit for antenna 40, etc.).

Device 10 may include a conductive interconnect structure 92 that passes through printed circuit board 88 and hole 102 to segment 58 on antenna arm 54. Conductive interconnect structure 92 may help to mechanically secure, attach, or affix printed circuit board 88 to top wall 42T if desired. Conductive interconnect structure 92 may also electrically couple conductive traces 90 to positive antenna feed terminal 34 on antenna arm 54.

Transmission line 84 may have a signal conductor coupled to conductive traces 90 and thus to positive antenna feed terminal 34 through radio-frequency components 94 and conductive interconnect structure 92. In this way, conductive traces 90 and conductive interconnect structure 92 may form part of the signal conductor for the transmission line path 26 (FIG. 1) that feeds antenna 40. Conductive interconnect structure 92, sometimes also referred to herein simply as conductive interconnect 92, may include a conductive screw, a conductive pin (e.g., a pogo pin), a conductive spring, a conductive clip, a conductive bracket, a conductive prong or finger, conductive adhesive, solder, welds, and/or any other desired conductive interconnect structures. In this way, antenna arm 54 may be fed by transmission line 84, conductive traces 90, and conductive interconnect structure 92 through conductive support plate 48 and/or top wall 42T.

If desired, device 10 may be provided with a dielectric cover layer 98 over conductive support plate 48 and/or top wall 42T. If desired, device 10 may be provided with a thin dielectric cover layer such as dielectric cover layer 100 over handle 50. Dielectric cover layer 100 may cover antenna arm 54 to prevent antenna arm 54 from shorting out, being damaged, and/or being detuned during operation of device 10 and/or when a user interacts with handle 50.

Device 10 may gather and/or use personally identifiable information. It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The foregoing is merely illustrative and various modifications can be made by those skilled in the art without departing from the scope and spirit of the described embodiments. The foregoing embodiments may be implemented individually or in any combination.

1. An electronic device comprising:
a housing having a conductive wall;
a handle having a leg that extends through an opening in the conductive wall; and
an antenna arm that is wrapped around the leg of the handle.

2. The electronic device of claim 1, wherein the antenna arm comprises a monopole arm that extends around a longitudinal axis of the leg.

3. The electronic device of claim 2, wherein the monopole arm extends at least 45 degrees around the longitudinal axis of the leg.

4. The electronic device of claim 2, wherein the monopole arm has a first segment that extends parallel to the longitudinal axis of the leg and has a second segment that extends orthogonally from an end of the first segment and around the longitudinal axis of the leg.

5. The electronic device of claim 4, wherein the monopole arm has a third segment that extends orthogonally from an end of the second segment and towards the conductive wall.

6. The electronic device of claim 4, wherein the second segment extends at least 90 degrees around the longitudinal axis of the leg.

7. The electronic device of claim 4, wherein the first segment exhibits a non-zero curvature about the longitudinal axis of the leg.

8. The electronic device of claim 1, wherein the antenna arm comprises a conductive trace on the leg of the handle, the electronic device further comprising:
a dielectric cover layer on the handle, wherein the dielectric cover layer covers the conductive trace.

9. The electronic device of claim 1, wherein the housing surrounds an interior of the electronic device, the electronic device further comprising:
a printed circuit board at the interior of the electronic device and having a signal trace;
a coaxial cable coupled to the signal trace; and
a conductive screw that extends through the conductive wall, that secures the printed circuit board to the conductive wall, and that electrically couples the signal trace to an antenna feed terminal on the antenna arm.

10-20. (canceled)

21. The electronic device of claim 1, further comprising:
a conductive plate disposed in the opening in the conductive wall, wherein the conductive plate includes an additional opening, the antenna arm is layered on the leg of the handle, and the leg of the handle extends through the additional opening.

22. The electronic device of claim 21, wherein the antenna arm is wrapped at least 180 degrees around the leg of the handle.

23. The electronic device of claim 1, wherein the antenna arm has a first segment extending along a first axis, a second segment extending from an end of the first segment along a second axis orthogonal to the first axis, and a third segment extending from an end of the second segment along a third axis parallel to the first axis.

24. The electronic device of claim 23, wherein the second segment extends around a longitudinal axis of the leg of the handle.

25. The electronic device of claim 24, wherein the first axis and the third axis are parallel to the longitudinal axis of the leg of the handle.

26. The electronic device of claim 23, further comprising:
a printed circuit board mounted to a side of the conductive plate opposite the handle;
a signal trace on the printed circuit board;
a transmission line coupled to the signal trace; and
a conductive interconnect that secures the printed circuit board to the conductive plate and that electrically couples the signal trace to the first segment of the antenna arm.

27. The electronic device of claim 21, wherein the conductive plate has a further opening, the leg extends through the additional opening, the handle includes an additional leg that extends through the further opening, and the handle includes a segment that couples the leg to the additional leg, the antenna arm being layered onto the leg of the handle.

28. The electronic device of claim 27, wherein the leg of the handle comprises dielectric, the antenna arm being layered onto the dielectric and extending around a longitudinal axis of the leg.

29. The electronic device of claim 1, wherein the antenna arm includes a monopole arm that comprises:
a first segment extending along a first axis and coupled to an antenna feed terminal,
a second segment extending from an end of the first segment and along a second axis orthogonal to the first axis, the second segment being wrapped around the leg of the handle, and
a third segment extending from an end of the second segment and along a third axis parallel to the first axis.

30. The electronic device of claim 29, wherein the conductive wall has a lateral surface, the second axis is parallel to the lateral surface, and the third segment extends from the end of the second segment towards the conductive wall.

31. The electronic device of claim 29, wherein the second segment extends at least 45 degrees around a longitudinal axis of the handle.
